(19) United States
(12) Patent Application Publication
(10) Pub. No.: US 2008/0154710 A1
(43) Pub. Date: Jun. 26, 2008

(54) Minimal Effort Prediction and Minimal Tooling Benefit Assessment for Semi-Automatic Code Porting

(76) Inventor: Pradeep Varma, New Delhi (IN)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/614,249

(22) Filed: Dec. 21, 2006

(51) Int. Cl. G06Q 10/00

(52) U.S. Cl. 705/11

(57) ABSTRACT

A method of computing effort requirements of porting issues in source code includes estimating the minimal number of code text characters needed to be read by a user when the user is searching for porting issues, estimating the minimal number of context switches needed to be made by the user when shifting from one reading region to another reading region during the searching for the porting issues, and estimating the minimal number of keystrokes needed to be made by the user during searching for the porting issues. In a similar manner, the method involves estimating the minimal number of code text characters, the minimal number of context switches, and the minimal number of keystrokes needed to be made by the user for found porting issues. With this information the method establishes an effort model based on a weighted sum of the minimal number of code text characters, the minimal number of context switches, and the minimal number of keystrokes, for individual porting issues. The weights in the model are identified by porting issue type and user capabilities in handling each porting issue.

### BACKGROUND

1. Field of the Invention

The embodiments of the invention generally relate to code porting and migration, and more particularly to an effort prediction tool for estimating the cost of application migration in source-to-source form.

2. Description of the Related Art

Within this application several publications are referenced by arabic numerals within parentheses. Full citations for these, and other, publications may be found at the end of the specification immediately preceding the claims. The disclosures of all these publications in their entireties are hereby expressly incorporated by reference into the present application for the purposes of indicating the background of the present invention and illustrating the state of the art.

Previous authors [5] have pointed out that in spite of the majority of software costs belonging to the post-development, software maintenance period, effort estimation for software maintenance has received less attention than the subject of ab initio software development. Other authors have [7] pointed out that the biggest problems of software maintenance are the lack of process models for maintenance and the lack of documentation of applications. Maintainers find little time to update existing documentation. A tool-based migration process can easily provide much value. Our work here addresses the cost prediction component pertinent to such migration processes.

One work [8] abstracts a program into a relational form that supports SQL queries that compute different metrics. This eases changing of metrics, process-specific metrics, and a larger variety of metrics. Standard metrics such as Chidamber and Kemerer (CK metrics) have been shown to be computable using this approach. Another author [2] shows a positive correlation among indirect quality attributes such as understandability and maintainability as obtained from practitioner surveys and as obtained by derivation from directly measured and computed metrics such as McCabe's Cyclomatic Number, Halstead's Volume, CK metrics and depth of nested statements. Another work [1] points out that adapting software to evolving customer usage (as by porting, say repeatedly) accompanied by inadequate documentation leads to reduced maintainability. A method based on analyzing and classifying defect data a posteriori, for a given project, is proposed for arriving at technical actions for overcoming product/process weaknesses. The work however is not designed for (a priori) effort prediction or a posteriori quantitative tool benefit estimation.

### SUMMARY

We propose a novel effort prediction tool, for estimating the cost of application migration in source-to-source form. Migration effort depends upon the kind of support tools available for the purpose, thus prediction is parameterized over tool assumptions. Reconciliation of actual cost (post migration) with predicted cost is tool supported and contributes to the tool's statistical model by providing more historical data to the same. All effort quantifications are minimal and then too only for the porting issue analysis and remediation activities. Code changes are assumed to be perfectly informed, thus no errors are introduced as a result of them. Costs of testing, debugging and the software engineering process (or lack thereof), and human/tool frailty are not modeled. The cost estimates therefore serve to primarily indicate relative hardness of individual migration steps vis-à-vis others which then assists project planning and identifies a lower bound against which migration efficiency can be calibrated.

Benefit assessment of a quality tool set over a lesser one can be carried out in the reconciliation phase (i.e. post migration phase). In this time, identification and remediation of porting issues is “complete” thus accurate effort estimation for both the toolsets can be done. Although the effort estimations remain minimal in nature, the activities that they cover (analyze and fix) overlap and a difference of the two yields the minimum benefit obtainable by using the better of the two.

Our tool is the first of its kind for the application migration domain and leverages the structural properties of the domain that most of the source remains unchanged, individual changes are small, and individual porting issues have manifest locations of concern which have to either be verified as safe (portable) or else changed to be safe. Minimal analysis cost from our perspective reduce to the search costs for the locations, which involves code reading and search-related keystrokes on part of the human practitioner. Verification and/or fix of the concerns again requires code reading and pertinent keystrokes from the human practitioner. A minimal estimation of the size of the code portions read and the keystrokes generated underpins our effort estimation method. To the extent that lightweight code reading and changes form the bulk of migration costs, our work claims an additional advantage of being scalable to actual (as opposed to minimal) analysis and remediation costs using historical knowledge of typical efficiency factors separating the minimal estimates and actual costs from prior projects.

In one specific embodiment, the invention comprises a method of computing effort requirements of porting issues in source code. The method includes estimating the minimal number of code text characters needed to be read by a user when the user is searching for porting issues, estimating the minimal number of context switches needed to be made by the user when shifting from one reading region to another reading region during the searching for the porting issues, and estimating the minimal number of keystrokes needed to be made by the user during searching for the porting issues. In a similar manner, the method involves estimating the minimal number of code text characters, the minimal number of context switches, and the minimal number of keystrokes needed to be made by the user for found porting issues.

With this information the method establishes an effort model based on a weighted sum of the minimal number of code text characters, the minimal number of context switches, and the minimal number of keystrokes, for individual porting issues. The weights in the model are identified by porting issue type and user capabilities in handling each porting issue. When estimating the minimal number of code text characters, the minimal number of context switches, and the minimal number of keystrokes, the method is performed in an apriori effort prediction process by using historical data and code metrics to classify porting code for projecting search and remedy information from the historical data and code metrics. The estimating of the minimal number of code text characters, the minimal number of context switches, and the minimal number of keystrokes is also performed in an a-posteriori benefit assessment process for a given toolset in the porting process by computing effort required when using a tool set as compared to a cost when not using the tool set in a baseline environment. The baseline environment comprises using only an editor for searching and fixing the porting issues. In addition, the method improves the historical data and code metrics and a corresponding classification mechanism by incorporating results from the a-posteriori benefit assessment process into the historical data and code metrics.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 illustrates a schematic diagram of illustrative distributions of the remediation options used for implicit casts;

FIG. 2 is a flow diagram illustrating a method of an embodiment of the invention; and

FIG. 3 is a flow diagram illustrating a method of an embodiment of the invention.

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

One writer [3] derives code chum, a metrics-based impact measure for code changes/deltas from one system build to another. Each change is expected to introduce new faults and the measure is oriented towards computing these new faults' impact and to guide software testing accordingly. Our work (described in detail below) is orthogonal to this focus, as we assume all porting issue fixes are perfect. Our effort is oriented towards finding a minimum cost needed to make the perfect fixes, with foreknowledge that any actual cost will exceed such minimum and will have bad fixes-related and testing costs also as addressed by [3]. While our effort can work in conjunction with an [3] kind of additional approach, the benefit from such conjunction may be reduced by the small-size of fixes for porting and the extent to which DAT-like tooling (described later) simplifies them (i.e. reduces their new fault potential).

The work [5] does effort prediction using software evolution metrics such as modules and subsystems created, changed and handled. The use of such coarse granularity metrics (compared to say lines of code—LOC) and observed prediction accuracy is suggested to be based on a higher level of functional integrity reflected by the system/module metrics. The authors of [5] also points out that the use of historical unplanned data, as in their work, has dangers such as a visible variable and its measured effects being actually the cause of an unmeasured latent variable; if the hidden variable next changes differently than the observed variable, the resulting prediction would be incorrect. The ability to build and train a model using historical data as in [5] may not be applicable to predicting for a specific maintenance task such as migration, since no prior migrations of the project may have taken place, or data of such a migration may not have been properly recorded. By contrast, our work is targeted specifically to migration effort prediction and using specific porting concerns-based fine-grained causal variables. In addition to prediction safety which our approach provides, our work also breaks down prediction effort in terms of individual porting step costs, which allows for scheduling and planning at individual steps level. This is much more valuable than lump-sum system prediction as made in [5] using system-level metrics.

One paper [4] argues for code change data as being a valuable source of insight that is not given adequate attention compared to other code properties. Using change data, [4] proposes a model for predicting remaining effort in a software development project, wherein each change is expected to introduce its own errors and changes are made for addition of new features, fixes to earlier errors, etc. Limitations of [4] are similar to [5], in terms of its use of historical, unplanned, albeit fine-grained data (e.g. log of change LOC count) for effort prediction and the (lack of) suitability of such data for the purpose of migration effort prediction. In predicting effort for a migration project, the model has to be concerned about all the issues that pre-exist in the project, as opposed to dynamic addition of new issues as a result of new changes made to the code.

Another work [6] suggests maintenance effort estimation in terms of multiplicative factors (code size, quality, complexity, and influence) and an impact domain of a planned maintenance task, but does not describe any impact analysis or other specific method applicable to migration tasks.

As a baseline for tool benefit assessment, we can assume that any migration enterprise has at its disposal a text editor for searching through and modifying code sources and an optional compiler for implementing at least a partial build (e.g. without linking to libraries) of the system at a minimum of one setting (e.g. source platform, target platform, some intermediate, maybe all). Tool support for migration can exceed this to be a static analysis tool, say the Deep Assessment Tool (DAT), [9], IBM Docket No: IN920050005, assigned U.S. patent application Ser. No. 11/388,353. Our benefit assessment and effort prediction tool is preferably embodied in terms additional machinery for the framework of DAT and is thus described. In our approach section later, the invention illustrates the effort computation of some porting issue search and fix analyses when a user has DAT at his disposal and when a user has only the baseline environment (editor+compiler) at his disposal. A difference of the two gives the benefit assessment of DAT over say freeware tooling support. The measure of effort in searching and remediating comprises: sizes of the source code fragments that have to be searched through/scanned manually; and the keystrokes required of a user in both issue search and remediation. The nature of keystrokes decide the effort contribution—say mouse clicks for a window change (e.g. from compiler error list to an editor), and a control characters sequence cost more than typing (the same number of) contiguous characters, etc.

The DAT framework is designed to be extensible via analysis and remediation plug-ins to cover an increasing set of porting issues. We reuse the same framework and propose plug-ins to model and compute minimal effort requirements for individual issues. The metrics used by individual effort plug-ins (e.g. expression count/size in a file) overlap, so these can be abstracted out and shared among the plug-ins in a manner analogous to [8]. We discuss next effort computation for four porting issues that are representative of large classes of porting issues: Implicit cast, which is a types analysis issue; Index out of scope, which is a syntax and scope analysis issue, an anachronism of C/C++ evolution; Application Programming Interface (API) issue, which pertains to library changes from platform to platform; and endian issue, which is an undecidable problem in general, requiring deep analyses (e.g. flow) for only approximate solutions.

The effort computation is detailed assuming DAT as the tool support as well as baseline (optional compiler+editor) as the tools support.\

Effort Related to the Implicit Cast Porting Issue

Consider the implicit casts porting issue, which comprises non-portable downcasts of floating numbers in C/C++ programs. Examples of such downcasts are illustrated in the code fragment below.

...
extern double bar(double);
int foo(int x) { return bar(x) ; }
int baz(int x)
{
int i = foo(2.3);
return i + bar(x);
}
...

Each of the underlined expressions in the fragment above is a downcast from single- or double-precision floating values to integral values. If DAT is the assumed tools support, the human cost of searching through code sources to identify (i.e. underline as above) these non-portable expressions is zero.

On the other hand, if baseline is the tools support and the compiler in the baseline environment does not print warning messages (or by some other means identify) such expressions, then a user has only the editor and its search capabilities to look for these expressions. For explicit cast expressions, there is the type cast syntax—parenthesized type—that provides some pattern to search for. No such support is available for implicit casts unfortunately and a user is stuck with a manual inspection of the entire set of expressions in the program/file to safely identify all implicit casts. At a minimum, code reading of the expression trees in the program has to be carried out and the cost of doing so incurred. Metrics such as number and size of expression nodes (and sub-nodes) are straightforwardly computed by DAT and can be used directly for such effort computation. In the context of compiler-generated warnings and error messages, additional modeling of the interaction between the compiler and practitioner has to be done as follows. The cost in this case is proportional to searching through the compiler output for implicit cast related strings, and then going back and forth from that to the editor environment to locate and remedy the implicit cast expressions. Typically an iterative break-by-compile, then fix loop is formed in the baseline environment to remedy individual issues, with an upper bound to how many errors/warnings the compiler can handle before breaking down. There is a substantial overhead of invoking the compiler anew each iteration. Later, we model the baseline environment with different parameters to characterize the benefit assessment.

Since DAT locates all implicit cast issues exactly, the guesswork in predicting DAT-related implicit cast costs lies solely in the extent to which a user uses non-standard solutions in fixing the implicit casts. Historical porting data, on the distribution of implicit cast solutions using one of the menu options (convert to explicit cast, convert to explicit cast after the floor function, convert to explicit cast after the ceiling function) or manually-written fixes can be used to determine the expected implicit casts-related cost in the context of DAT. The goodness of the use of history depends on how well the subset of the history relevant to the present migration is found. Classification of the history thus, and mapping a file to be migrated to its natural class is discussed next.

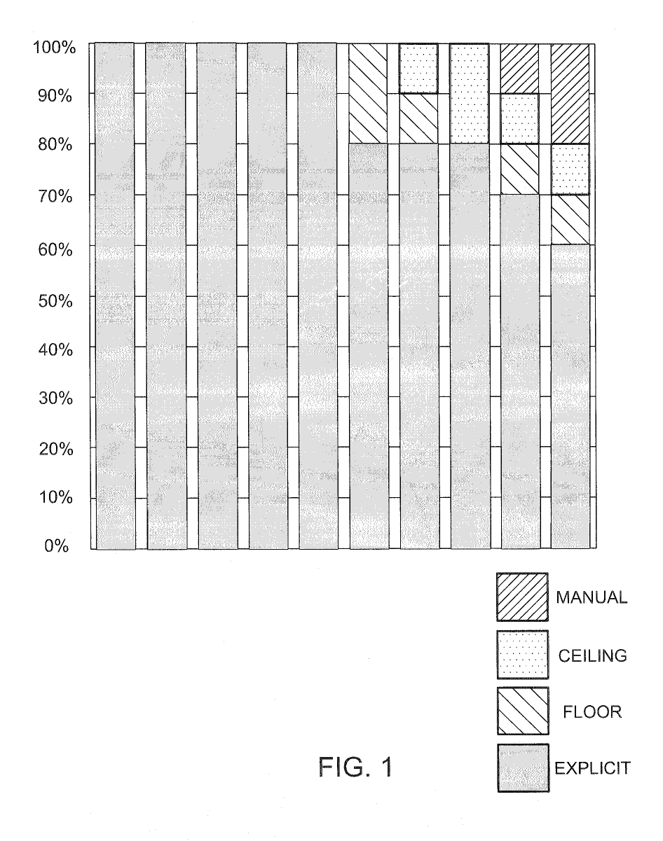

FIG. 1 shows an illustrative set of distributions of the remediation options used for implicit casts. Each bar in FIG. 1 corresponds to a cluster of “similar” files and shows the percentages of different remediation options used for the same. Many of the bars have the same behavior, implict cast distributionwise, so the classification into clusters as illustrated entertains nuances that although not pertinent to implicit casts, may have relevance for other issues. Many different options for defining the clusters can exist, such as project wise and code metrics wise (e.g. Chidamber and Kemerer metrics, simple metrics like similar expression counts, density of implicit cast issues per lines of code (or expressions), etc.). The quality of the history-based prediction depends upon the mapping of the file being ported to a cluster and use of the implicit cast statistics available for the cluster. The “similarity” of individual files belonging to a cluster can be captured by different coefficients of correlation (e.g. Pearson product-moment coefficient of linear correlation, Spearman rank correlation coefficient) between an individual metric and the remediation classification of implicit casts identified by the metric. For each of the many different clustering options possible (one per metric), a projected cluster can be identified as above. Different projections from different metrics can be combined analogously (e.g. weighted average of projections, with correlation coefficients identifying the weights) into one final figure.

Predictions become more accurate as remediation proceeds, since the population of un-fixed issues requiring guesswork keeps on going down. History-based classification and cost projection for individual files can be an interactive process, requiring human intervention, or a fully automatic formula. The latter is more likely to be used once the interactive experience matures after some projects and well-defined formulae arise from the same.

Once a projection of the expected number of fixes of different kinds is settled upon, the minimum effort of remediation can be arrived at by simply multiplying the minimum cost per fix kind with the number of fixes of the kind. For manual remediation, the cost is derived from the keystrokes needed for the typing/editing pertinent to the manual remediation (averages from history data can be used in the predictive phase). For batch remediation using DAT, the remediation costs are not multiplicative, but that can be handled straightforwardly using batch weights and the expectations of the file belonging to a group permitting batch remediation (left 5 bars). Computing batch remediation cost depends upon whether the software engineering process of DAT use advises batch remediation or not. If the process insists upon the user visiting each issue individually, maybe just to scan it, then multiplicative costs for the number of issues becomes the norm. In the reconciliation phase, the sequence of keystrokes used is known, and thus factors for batch vs. interactive remediation precisely.

Index-Out-of-Scope Porting Issue

The following code fragment displays the index-out-of-scope porting issue. A for-loop in certain old C/C++ dialects treated variables declared in the loop header to be considered as belonging to the scope surrounding the for-loop. The for-loops declaring index variables j, k, and p in the fragment below explicitly manifest this behavior. For each of these variables, the declaration as well as its reference outside the declaring loop's body are shown underlined.

```
...
int main( )
{
for(int i=0; i< 8; i ++)
{
  for(int j = 0; j < 8; i−−)
    i = i+ j;
  for(int k =0; k < 8; k= k+ j);
  for(int p=0; p < 8; p++ )
    p = p+ k;
  for (int foo = 0; foo < p; foo = foo + 3.2);
  }
return 1.2;
}
...
```

Consider the scenario of migrating away from the old for loops. If all references of a variable declared in an old for loop are contained within the loop, then the loop is amenable to straightforward interpretation as a modem for loop (i.e. a loop which restricts the references to within itself). On the other hand, if for some old loops, the variables are referenced beyond the loops, like in the code fragment above, then these loops can be processed as follows. The offending variable declarations are lifted out of the loop headers and placed in the surrounding scope. This standardizes references to the variables within the loop bodies and beyond, eliminating concerns pertaining to the (previously) offending references.

For DAT, identification and automated remediation of old for loops as described is straightforward. If user involvement is reduced to inspecting each remediation as it takes place, the cost is proportional to the number of for loops (not index variables) with variables referenced beyond the loops. Again, similar to implicit casts, a statistical distribution of how many such remediations are carried out automatically, as opposed to user-typed, can lead to effort projection that accounts for user intervention.

In baseline tooling, a compiler invocation using modern loop settings can lead to identification of some offending, out-of-loop references as unknown variable errors. If the scope stack surrounding such a reference is searched and a for loop declaring the variable as a child scope of one of the ancestor scopes of the reference expression is found, then the loop (and reference) can be identified as an old-for-loop issue. For this, a search up the scope stack, for preceding declarations which exist within the global entity (e.g. global procedure) containing the unknown variable reference has to be carried out. Other offending out-of-loop variable references, not caught as unknown variable errors may still be present in the program, with the compiler misinterpreting them as bound to the same variable name declaration in a surrounding common ancestor scope of the offending loop and the offending reference. For such references, the compiler support offers no benefit and an editor-based human search has to be carried out as follows. For each for-loop, search through its out-of-loop, old-for-loop scope region for offending references to loop-declared variables.

The cost of compiler-identified offending variables is minimally the lesser of (a) the effort for human reading of the code text between its declaration in the for-loop and the first identified offending reference (b) the effort for a search of the variable name string through the same text, generating the keystrokes needed for a user to carry out the same, while accounting for repeat command invocations in order to skip over name matches in comments, subsets of other strings etc. Both of these efforts are straightforwardly computed using DAT technology and the minimum of the two obtained. For the non-compiler supported human search using editor technology, an analogous effort estimation has to be carried out through each for loop's out-of-loop, old-for-loop scope region. The entire region has to be searched through and verified in case of variables with no offending references. The effort estimation takes the minimum of efforts analogous to (a) and (b) above.

Remediation of index-out-of-scope issue in baseline tooling is fully manual, whose effort can be estimated by the text manipulation engendered for each issue. Given the knowledge of such text generation from automatic remediation in DAT and history data, the effort estimation is straightforward.

Application Programming Interface (API) Issues

A common migration issue is the change of a library function name, type or use, from the source to target platform. The following code fragment shows the use of a Posix threads library function, pthread_getspecific, which changes in both name and method use in migrating to another threads package. The corresponding function on target side is thr_getspecific, which unlike pthread_getspecific returns the answer by a side-effect to a pass-by-reference argument variable and not by the function return value. The remediation to the original line in code source is the commented line shown below the same in the fragment below.

...
int main( )
{
...
val = pthread_getspecific(key);
/* (thr_getspecific(key, &val), val); */
...
}

In DAT, each non-portable function application invoking a named library function can straightforwardly be found. Remediation support in terms of renaming a function (to target name), and rewriting the call according to target type and use can also be straightforwardly provided. While search and automated remediation cost for such API issues becomes negligible, the option of manual remediation and its contribution to API remediation effort becomes significant, which then has to be predicted using historical data on the extent to which manual remediation is used and its average efficiency (in terms of text overhead compared to automatically generated text, all of which lead to keystrokes-based effort accounting).

In the context of baseline tooling without compiler support, searching for API issues can be carried out by searching for an API name (with migration concerns) as a string in the code sources. This can be done using either the editor, or using the grep facility. Each function application found using a searched for API string needs to be checked next for referring actually to the library function, as opposed to a local variable with the same name, or text in a comment/string etc. This involves searching up the lexical scope stack surrounding the function application and also the availability of the library API at the global scope level by appropriate include statements. Overhead of the include statements analysis for a given file can be shared among the name strings found in the file. The checking also has to screen against name overloading which adds to the cost of identifying a function name as a specific problematic API. Such screening involves careful reading of the function application to the least extent needed to discriminate between different overloaded names such as the number of arguments, the type of a specific argument, the types of all arguments etc. Evaluating the type of an argument expression in the worst case involves lookup of the types of its variable terms in the surrounding lexical scope stack. Computing this effort, and the rest for manual API analysis as discussed above involves techniques similar to the variable references discussion in the index-out-of-scope section earlier.

Baseline tooling wherein at least unit builds are possible using a compiler at the target platform setting can offer some benefit in searching for problematic APIs. Function applications with changed API names in the case when there is no (other) target platform API name matching with the source API name, will result in undefined variable error. On the other hand, API calls with the same type signature but reordered arguments will not be caught in this manner. Ability to use compiler support means that for a subset of problematic APIs, the search will be carried out using such support. For the rest, the editor/grep based method discussed above has to be carried out.

Remediation costs in the baseline environment for API issues are all manual costs that can be computed similar to the manual option costs for DAT-based remediation.

Endian Migration Issue

Commercially important but hard to analyze issues arise from migrations involving hardware platform changes—Little Endian hardware to Big Endian and vice versa. Code written assuming one of the Endian hardware may have the data layout assumptions pertaining to the platform built into it with difficulties in porting the same to a different Endian platform. For example consider the union type declared in the code fragment for a little Endian platform below. On the little Endian platform, the character array overlays the bytes of the integer i least significant byte onwards (a[0] to least significant byte, . . . , a[3] to most significant byte). On a big Endian platform, the character array overlays in the opposite order (a[0] to most significant byte, . . . , a[3] to least significant byte). Succeeding code, assuming one of the two overlays (say that char[0] is least significant as on little Endian) breaks if used unchanged on the other platform.

```
...
union U{
int i;
char a[4];
} u;
int main( )
{
char CC[N];
int * II;
scanf(“%s”,CC);
II= (int *) CC;
II++;
    /* #ifdef LittleEndian */
u.i = *II + 5;
printf(“%c %c”, u.a[0], u.a[1]);
return u.i ;
    /* #else
    u.i = *II;
    u.i = u.a[3] * 0X1000000 + u.a[2] * 0X10000 + u.a[1] * 0X100+
                                                    u.a[0]+5;
    printf(“%c %c”, u.a[3], u.a[2]);
    return u.i ;
    #endif
    */
}
```

Another Endian issue arises from explicit casts carried out using pointer types, as for example shown in the assignment to II in the procedure main above. This causes another overlay of an integer and a character, which may result in non-portable code in the surrounding context.

One possible remediation of the Endian issues in the code above is via addition of the code shown in comments in the above fragment. All text in comments is indented for convenience. The code assumes the use of a compiler symbol, LittleEndian to indicate whether a platform is little Endian or not.

A range of detectors for the Endian problem are possible, depending on the extent to which they engage sophisticated compiler techniques such as syntax analysis, type analysis and data flow analysis. For example, a simple detector would identify all union declarations in a program as a potential source of Endian issues. A more sophisticated detector would crosscheck the types inside the union to ensure that the individual field types are indeed different. A flow analysis based detector would try to relate flow of values in the vicinity of union and cast expressions to identify Endian issues. Due to the undecidable nature of the Endian problem, all detectors (and therefore semi-automatic remediators) can serve to identify only approximate span of the Endian issues in a generic program. Cost projection for the remainder of the problem has to be posited based on historical experience/data with the problem. We show how to do so for a simple syntax and types-based DAT detector in detail as follows. Details for the other detectors can be developed in an analogous manner straightforwardly.

From historical data, we seek answers to the following questions: 1. For an identified set of concerns (say union declarations of differing types, pointer casts), what fraction actually lead to Endian issues? 2. For each concern that actually leads to a set of Endian issues, what is the total size of the syntactic constructs in the minimal human read/search path from the concern to the manifestation point of the actual issue? A DAT plug-in can be used to size the constructs straightforwardly, upon a practitioner-based highlighting and recording of the actual control/dependency path comprising AST edges in historical instances of Endian remediation. Overlaps between paths from one concern to its set of issues are counted only once.

The answer to question 1 helps scale the concerns identified in a given project to the ones with actual issue potential. This scaled number multiplied by the average size obtained in question 2 leads to a projection for the overall search size pertaining to detecting the Endian issues in the program. Note that these questions are overly minimal in estimating the search size for Endian, since scaling literally by the answer to QI ignores the effort involved in routine disqualification of say a pointer cast as an Endian issue. Similarly, in question 2, the effort estimate only includes positive Endian issues and not the effort for disqualifying potential but negative issues. In order to make effort estimate include these disqualification costs, the DAT-based Endian practice can be modified to enable a practitioner to also highlight and record the text searched through for disqualifying potential Endian issues. While doing this for historical data is also possible, the costs involved may preclude the effort. Once adequate statistics for the Endian search are available, the questions above can be revised to seek disqualification costs in conjunction with positive issue costs.

Note that the above questions remain essentially classification problems as in implicit casts, since only average behaviors are needed for the answers, just that the averages have to correspond to the right historical codes.

Endian analysis using baseline tools involves additional search costs for union declarations, union references, and pointer cast expressions. Compiler support offers no benefit to Endian, since it is purely a run-time issue. The additional search costs for unions and casts can be computed similar to the searches discussed for implicits casts and index-out-of-scope. The disqualification costs for pruning the unions and pointer casts to the subset identified by the DAT Endian analyzer under discussion are similarly straightforward to add.

If a more sophisticated (say flow analysis based) Endian analyzer replaces the present one based on syntax and types analysis, then the code highlights (for questions 1 and 2 above) for Endian get subset, automatically, straightforwardly, since the analyzer eliminates some of the previous human efforts in disqualifying false positives and/or establishing true positives.

For estimating remediation cost related to Endian issues, a third question is sought to be answered using historical data: 3. For each concern that actually leads to a set of Endian issues, what are the deletions and additions of text pertaining to the remediation of the concern?

Again, as for question 2, DAT support can assist in computing the response to this question. With the answer to question 3 in hand, total concerns scaled by the answer to question 1, multiplied by an average remediation-related keystrokes cost computed from the answer in question 3 provides the cost projection for remediating Endian issues in a given program. The total Endian projection is the sum of the search related cost and the remediation cost.

Capability Overview

As described, we can build tooling for estimating minimal human effort required in analyzing and remediating code to be migrated. The tool can be used for effort prediction before migration as well as effort accounting after migration. If migration is carried out using sophisticated tools like the Research DAT, and the accounted effort after migration is compared with (an accurate) predicted effort using freeware tooling, then the benefit obtained by using DAT gets quantified. The model underlying the tool can handle a variety of support tools for migration and not just DAT alone. Indeed the model is agnostic to whether a hypothetical, more sophisticated tool than DAT is used for migration or not (e.g. an unrealizable oracle to identify exact issues everywhere). Although the prediction goodness is tied to DAT-quality technology and historical data, the reconciliation phase of the effort measurement (i.e. post migration) is independent of this quality limitation as by this phase, the knowledge of a given migration project's issues is “complete”. In other words, post migration, an oracle can be assumed more realistically, in order to guide prediction for and accounting analyses.

Besides estimating search and remedy costs of a known set of porting issues, the method described here can also be used to estimate search and remedy costs for issues types that may not be known apriori. For this, a tabulation of search and remedy costs of a category called miscellaneous issues can be made in historical data. A classification of project codes/files with historical data would identify matching clusters that manifest a proportion of extra costs as miscellaneous costs. Effort predictions can be increased by the projected miscellaneous issues to arrive at total costs. Finally, post migration, the historical data can be improved with the current project's contributions of actually found miscellaneous issues beyond the mainstream porting issue categories.

Implementation issues.

Plug-ins identifying search spaces for individual porting issues can be built straightforwardly in the DAT framework. The search space metric can be a measure like the count of nested expressions (for implicit casts), or can be the actual text size read through by a human being (the number of characters comprising the outermost expression). The former gains size through the measure of nesting, the latter through actual one-time count of characters in the nested expression. Minimal keystrokes needed for searching can be estimated by identifying pages associated with search spaces and the need to skip through the same. Default display sizes can be assumed or read in from a knowledge base identifying user profiles (preferred display attributes). Keystrokes involved in user operations such as keyword searches can be customized to the matches computed for the searches by the DAT plug-in on the program representation in text and AST form. Remediation keystrokes are available from historical data stored in a knowledge base. For a given porting issue, once search size estimates, search keystroke estimates, and remediation keystroke estimates become available, the same can be converted into effort estimates based upon scaling factors availed from the knowledge base. The scaling factors are tool specific and are computed through experimentation by practitioners using different tools like the DAT and baseline editor in carrying out porting.

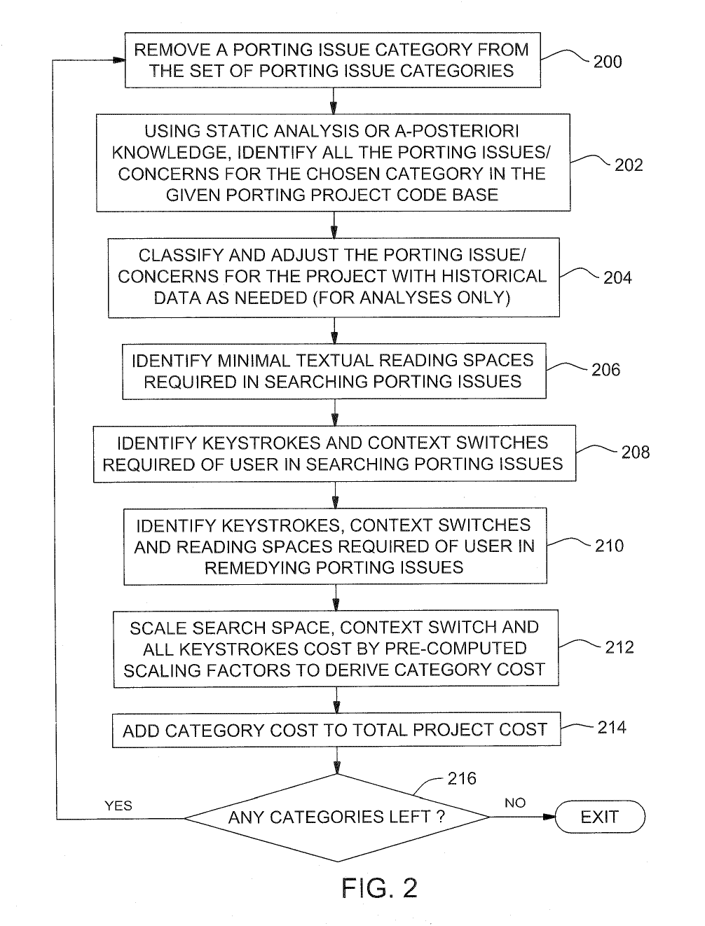

The general flow of effort computation in porting projects is given in FIG. 2. More specifically, in item 200, the process removes any porting issue category from the set of porting issue categories. Next, in item 202, the process proceeds by using static analysis or a-posteriori knowledge to identify all the porting issues and concerns for the chosen category in the given porting project codebase. Continuing on to item 204, the process classifies and adjusts the porting issues and concerns for the project with historical data as needed (for static analyses only). Next in item 206, the process identifies minimal textual reading spaces required in searching porting issues. Following this, in item 208, the process identifies keystrokes and context switches required of the user in searching porting issues. Similarly, in item 210, the process of that identifies keystrokes, context switches and reading spaces required of a user in remedying porting issues. In item 212, the process scales the search space, context switch and all keystrokes costs by pre-computed scaling factors to derive a category cost. In item 214, the process adds a category cost to the total project cost. In the decision box 216, the process determines whether any categories are left including the miscellaneous issues category. If there are not, the process exits. If there are categories last, the process returns to item 200 and loops through an additional time.

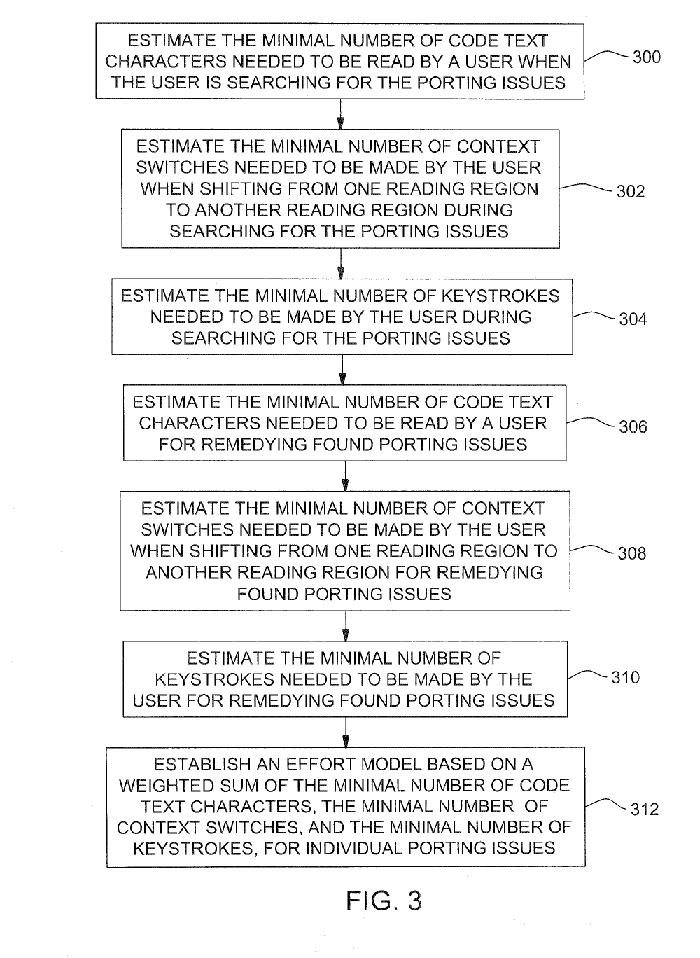

A more specific flow diagram to one implementation is shown in FIG. 3. More specifically, in item 300, the method estimates the minimal number of code text characters needed to be read by a user when the user is searching for porting issues. Similarly, in item 302, the method estimates the minimal number of context switches needed to be made by the user when shifting from one reading region to another reading region during the searching for the porting issues, and in item 304, the method estimates the minimal number of keystrokes needed to be made by the user during searching for the porting issues. In a similar manner, the method involves estimating the minimal number of code text characters (306), the minimal number of context switches (308), and the minimal number of keystrokes (310) needed to be made by the user for remedying found porting issues.

With this information the method establishes an effort model (in item 312) based on a weighted sum of the minimal number of code text characters, the minimal number of context switches, and the minimal number of keystrokes, for individual porting issues. The weights in the model are identified by porting issue type and user capabilities in handling each porting issue.

When estimating of the minimal number of code text characters, the minimal number of context switches, and the minimal number of keystrokes, the method is performed in an apriori effort prediction process by using historical data and code metrics to classify porting code for projecting search and remedy information from the historical data and code metrics. The estimating of the minimal number of code text characters, the minimal number of context switches, and the minimal number of keystrokes is also performed in an a-posteriori benefit assessment process for a given toolset in the porting process by computing effort required when using a tool set as compared to a cost when not using the tool set in a baseline environment. The a-posteriori benefit assessment process comprises using only an editor for searching and fixing the porting issues. In addition, the method improves the historical data and code metrics and a corresponding classification mechanism by incorporating results from the a-posteriori benefit assessment process into the historical data and code metrics.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. An example of such an adaption/modification is to weight context switches in cost computations proportionally by size of new/old read regions as opposed to only pre-computed weights. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

### REFERENCES

[1] K. Bassin, P. Santhanam: “Managing the Maintenance of Ported, Outsourced, and Legacy Software via Orthogonal Defect Classification”, In Proceedings of IEEE International Conference on Software Maintenance 2001, pages 726-735.
[2] F. Dandashi: “A Method for Assessing the Reusability of Object-Oriented Code Using a Validated Set of Automated Measurements”, In Proceedings of ACM Symposium on Applied Computing 2002, pages 997-1003.
[3] S. G. Elbaum, J. C. Munson: “Code Chum: A Measure for Estimating the Impact of Code Change”, In Proceedings of IEEE International Conference on Software Maintenance 1998, pages 24-33.
[4] A. Mockus, D. M. Weiss, P. Zhang: “Understanding and Predicting Effort in Software Projects” In Proceedings of IEEE International Conference on Software Engineering 2003, pages 274-284.
[5] J. F. Ramil, M. M. Lehman: “Metrics of Software Evolution as Effort Predictors—A Case Study”, In Proceedings of IEEE International Conference on Software Maintenance 2000, pages 163-172.
[6] H. M. Sneed: “Estimating the Costs of Software Maintenance Tasks”, In Proceedings of IEEE International Conference on Software Maintenance 1995, pages 168-181.
[7] M. J. C. Sousa, H. M. Moreira: “A Survey on the Software Maintenance Process”, In Proceedings of IEEE International Conference on Software Maintenance 1998, pages 265-274.
[8] M. Scotto, A. Sillitti, G. Succi, T. Vernazza: “A Relational Approach to Software Metrics”, In Proceedings of ACM Symposium on Applied Computing 2004, pages 1536-1540.
[9] Pazel et al., “A Framework and Tool for Porting Assessment and Remediation,” In Proceedings of IEEE International Conference on Software Maintenance 2004, page 504.

What is claimed is:

1. A method of computing effort requirements of porting issues in source code comprising:
estimating a minimal number of code text characters needed to be read by a user when said user is searching for porting issues;
estimating a minimal number of context switches needed to be made by said user when shifting from one reading region to another reading region during said searching for said porting issues;
estimating a minimal number of keystrokes needed to be made by said user during said searching for said porting issues;
estimating a minimal number of read code text characters, a minimal number of context switches, and a minimal number of keystrokes needed to be made by said user for remedying found porting issues; and
establishing an effort model based on a weighted sum of said minimal number of code text characters, said minimal number of context switches, and said minimal number of keystrokes, for individual porting issues with weights being identified by porting issue type and user capabilities in handling each porting issue.

2. The method according to claim 1, wherein said estimating of said minimal number of code text characters, said minimal number of context switches, and said minimal number of keystrokes is performed in an apriori effort prediction process using static analyses and by using historical data and code metrics to classify porting code for projecting search and remedy information from said historical data and code metrics.

3. The method according to claim 2, wherein said estimating of said minimal number of code text characters, said minimal number of context switches, and said minimal number of keystrokes is performed in an a-posteriori benefit assessment process for a given toolset in the porting process by computing effort required when using a tool set as compared to a cost when not using said tool set in a baseline environment comprising using only an editor and an optional compiler for searching and fixing said porting issues.

4. The method according to claim 3, further comprising improving said historical data and code metrics and a corresponding classification mechanism by incorporating results from said a-posteriori benefit assessment process into said historical data and code metrics.

5. A method of computing effort requirements of porting issues in source code comprising:
estimating a minimal number of code text characters needed to be read by a user when said user is searching for porting issues;
estimating a minimal number of context switches needed to be made by said user when shifting from one reading region to another reading region during said searching for said porting issues;
estimating a minimal number of keystrokes needed to be made by said user during said searching for said porting issues;
estimating a minimal number of read code text characters, a minimal number of context switches, and a minimal number of keystrokes needed to be made by said user for remedying found porting issues; and
establishing an effort model based on a weighted sum of said minimal number of code text characters, said minimal number of context switches, and said minimal number of keystrokes, for individual porting issues with weights being identified by porting issue type and user capabilities in handling each porting issue,
wherein said estimating of said minimal number of code text characters, said minimal number of context switches, and said minimal number of keystrokes is performed in an apriori effort prediction process by static analyses and by using historical data and code metrics to classify porting code for projecting search and remedy information from said historical data and code metrics, and
wherein said estimating of said minimal number of code text characters, said minimal number of context switches, and said minimal number of keystrokes is performed in an a-posteriori benefit assessment process for a given toolset in the porting process by computing effort required when using a tool set as compared to a cost when not using said tool set in a baseline environment comprising using only an editor and an optional compiler for searching and fixing said porting issues.

6. The method according to claim 5, further comprising improving said historical data and code metrics and a corresponding classification mechanism by incorporating results from said a-posteriori benefit assessment process into said historical data and code metrics.
